(19) United States
(12) Patent Application Publication
(10) Pub. No.: US 2025/0341535 A1
(43) Pub. Date: Nov. 6, 2025

(54) ANALYTICAL DEVICE

(71) Applicant: FUJIFILM CORPORATION, Tokyo (JP)

(72) Inventor: Yoshinori TANAKA, Kanagawa (JP)

(21) Appl. No.: 19/271,802

(22) Filed: Jul. 17, 2025

Related U.S. Application Data
(63) Continuation of application No. PCT/JP2023/044897, filed on Dec. 14, 2023.

(30) Foreign Application Priority Data
Jan. 24, 2023 (JP) 2023-008922

(51) Int. Cl. G01N 35/04; G01N 35/00; G01N 35/10

(52) U.S. Cl. CPC G01N 35/04; G01N 35/10; G01N 2035/00356; G01N 2035/0441

(57) ABSTRACT

An analyzer includes an incubator that has a rotary table configured to rotate in such a manner as to sequentially transport a plurality of analysis chips to a measurement position and that heats the plurality of analysis chips on the rotary table to a predetermined temperature, a measurement unit that is disposed at the measurement position and that measures a test substance sample spotted on the plurality of analysis chips, a transfer mechanism that transfers the analysis chips from a spotting position at which the test substance sample is spotted onto the analysis chips to the cells inside the incubator, a return mechanism that returns the analysis chips preheated in the incubator before the test substance sample is spotted onto the analysis chips from the cells inside the incubator to the spotting position, and a discard mechanism that transfers the analysis chips having undergone measurement from the cells inside the incubator to a discard position. The return mechanism and the discard mechanism share at least one component.

### CROSS-REFERENCE TO RELATED APPLICATIONS

This application is a continuation application of International Application No. PCT/JP2023/044897, filed Dec. 14, 2023, the disclosure of which is incorporated herein by reference in its entirety. Further, this application claims priority from Japanese Patent Application No. 2023-008922, filed Jan. 24, 2023, the disclosure of which is incorporated herein by reference in its entirety.

### BACKGROUND

### 1. Technical Field

The present disclosure relates to an analyzer.

### 2. Related Art

An analyzer is known that analyzes a test substance sample by using an analysis chip on which the test substance sample is spotted (see, for example, JP2002-90377A). To analyze the test substance sample, for example, the concentration of a test target analyte contained in the test substance sample is measured by measuring the reaction state between the test substance sample and a reagent. The test substance sample is, for example, blood, urine, or the like. The analysis chip is, for example, a dry analysis chip using a solid-phase reagent.

The analyzer includes an incubator that heats a plurality of analysis chips in order to ensure a suitable measurement condition. The incubator includes, for example, a rotary table on which a plurality of cells that holds the plurality of analysis chips are arranged in a circumferential direction.

A spotting position at which the test substance sample is spotted onto the analysis chips is provided outside the incubator. After the test substance sample has been spotted on the analysis chips at the spotting position, the analysis chips, on each of which the test substance sample has been spotted, are transferred from the spotting position into the incubator by a transfer mechanism.

Measurement of the analysis chips is performed in the incubator, and the analysis chips that have been measured are discarded to a discard position located outside the incubator by a discard mechanism.

### SUMMARY

In such an analyzer, it has been considered to preheat analysis chips by using an incubator before a test substance sample is spotted onto the analysis chips. By performing such preheating, the temperature of each of the analysis chips at the time of spotting the test substance sample can be matched to a predetermined target temperature, thereby allowing a measurement condition to be made uniform among the analysis chips.

However, in the case of performing preheating before spotting, a return mechanism that returns the analysis chips, which have once been sent to the incubator for the preheating, back to a spotting position is required. Such an analyzer has a transfer mechanism and a discard mechanism as mentioned above, and if the return mechanism is added to the analyzer in addition to these mechanisms, there is a concern that the structure will become complex and the size of the analyzer will increase.

The technology of the present disclosure provides an analyzer capable of achieving structural simplification and size reduction, even in the case where an incubator is used for preheating.

A first aspect according to the technology of the present disclosure is an analyzer that analyzes a test substance sample by using a plurality of analysis chips onto which the test substance sample is to be spotted, the plurality of analysis chips being configured to be detachably loaded into the analyzer, the analyzer including an incubator that has a rotary table on which a plurality of cells each of which holds one of the plurality of analysis chips are arranged in a circumferential direction, the rotary table being configured to rotate in such a manner as to sequentially transport the plurality of analysis chips to a measurement position, and that heats the plurality of analysis chips on the rotary table to a predetermined temperature, a measurement unit that is disposed at the measurement position and that measures the test substance sample spotted on the plurality of analysis chips, a transfer mechanism that transfers the analysis chips from a spotting position at which the test substance sample is spotted onto the analysis chips to the cells inside the incubator, a return mechanism that returns the analysis chips preheated in the incubator before the test substance sample is spotted onto the analysis chips from the cells inside the incubator to the spotting position, and a discard mechanism that transfers the analysis chips having undergone measurement from the cells inside the incubator to a discard position. A portion of the return mechanism and a portion of the discard mechanism are shared.

A second aspect according to the technology of the present disclosure is the analyzer according to the first aspect, in which, when the rotary table is viewed in plan view, the return mechanism and the discard mechanism are arranged inside a plurality of cells that are arranged in the circumferential direction of the rotary table.

A third aspect according to the technology of the present disclosure is the analyzer according to the first aspect, in which the return mechanism has a slide bar that is disposed in such a manner as to be slidable in a radial direction of the rotary table and that pushes each of the analysis chips on the cells toward the spotting position located outside the rotary table. The discard mechanism has a slide bar that is disposed in such a manner as to be slidable in a radial direction of the rotary table and that pushes each of the analysis chips on the cells toward the discard position located outside the rotary table. The slide bar is shared by the return mechanism and the discard mechanism.

A fourth aspect according to the technology of the present disclosure is the analyzer according to the third aspect, in which the spotting position and the discard position are arranged at an angular interval of 180 degrees in a circumferential direction of the rotary table.

A fifth aspect according to the technology of the present disclosure is the analyzer according to the first aspect, in which the measurement unit has a first measurement unit that optically measures a reaction state between the test substance sample and a reagent and a second measurement unit that measures concentration of an electrolyte contained in the test substance sample by using an electrode. The analysis chips include a first analysis chip to be measured by the first measurement unit and a second analysis chip to be measured by the second measurement unit. The rotary table has a first cell that holds the first analysis chip and a second cell that holds the second analysis chip. The return mechanism and the discard mechanism are used for both the first analysis chip and the second analysis chip.

A sixth aspect according to the technology of the present disclosure is the analyzer according to the first aspect, in which the plurality of analysis chips held in the plurality of cells of the rotary table are a plurality of types of analysis chips for different measurement items.

A seventh aspect according to the technology of the present disclosure is the analyzer according to the first aspect, in which each of the analysis chips is a dry analysis chip using a solid-phase reagent as a reagent.

According to the technology of the present disclosure, an analyzer is provided that is capable of achieving structural simplification and size reduction, even in the case where an incubator is used for preheating.

### BRIEF DESCRIPTION OF THE DRAWINGS

Exemplary embodiments according to the technique of the present disclosure will be described in detail based on the following figures, wherein:

FIG. 1 is a schematic diagram illustrating an overall configuration of an analyzer according to an embodiment;

FIG. 2 is an external perspective view of an incubator;

FIG. 3 is an exploded perspective view of the incubator;

FIG. 4 is a sectional view of the incubator;

FIG. 5 is an external perspective view illustrating a structural example of a colorimetric chip;

FIG. 6 is an external perspective view illustrating a structural example of an electrolyte chip;

FIG. 7 is a schematic diagram illustrating a partial configuration of the analyzer;

FIG. 8 is a plan view illustrating a configuration example of the analyzer;

FIG. 9 is a plan view illustrating a configuration example of the analyzer;

FIG. 10 is a schematic diagram illustrating a state of measurement using a colorimetric method in the analyzer;

FIG. 11 is a plan view illustrating a configuration example of the analyzer;

FIG. 12 is a plan view illustrating a configuration example of the analyzer;

FIG. 13 is a plan view illustrating a configuration example of the analyzer; and

FIG. 14 is a flow chart illustrating a process of analyzing a test substance sample in the analyzer.

### DETAILED DESCRIPTION

An embodiment of the present disclosure will be described in detail below with reference to the drawings.

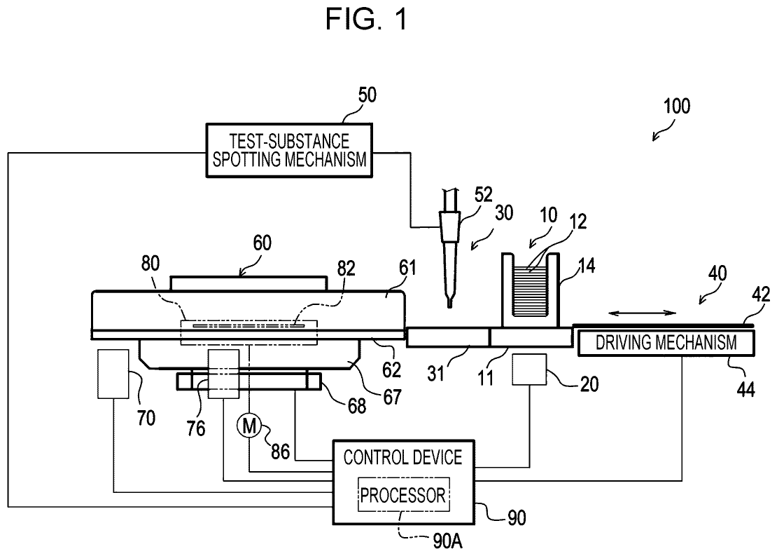

FIG. 1 is a schematic diagram illustrating the overall configuration of an analyzer 100 according to the embodiment.

As an example, as illustrated in FIG. 1, the analyzer 100 is an analyzer that analyzes a test substance sample. In the analyzer 100, for example, dry analysis chips 12 are used, and the concentration of a test target analyte contained in the test substance sample is measured. When the analysis chips 12 are each in the form of a flat plate, they are also called, for example, slides. The analyzer 100 is an example of an “analyzer” according to the technology of the present disclosure.

Specifically, blood is used as the test substance sample in the analyzer 100, and the concentration of a test target analyte contained in the blood is optically measured. More specifically, the concentration of the test target analyte is measured by a colorimetric method. In the analyzer 100, blood or urine is used as the test substance sample, and the concentration of electrolytes contained in the blood or urine is measured. Specifically, the concentration of ions (e.g., sodium (Na), potassium (K), or chloride (Cl) ions) that are generated by dissociation of electrolytes contained in the blood or urine is electrically measured. More specifically, the concentration of ions subject to measurement using an electrode method is measured.

The analyzer 100 includes a chip set unit 10, a reader 20, a test-substance spotting unit 30, a first chip transport mechanism 40, a test-substance spotting mechanism 50, an incubator 60, an optical measurement unit 70, a potential measurement unit 76, a second chip transport mechanism 80, and a control device 90.

In the chip set unit 10, a stocker 14 that accommodates the analysis chips 12 is disposed on a holding base 11. The plurality of analysis chips 12 are stacked and accommodated in the stocker 14. The analysis chips 12 include analysis chips 12A (hereinafter simply referred to as “colorimetric chips 12A”) that are used for optical concentration measurement using the colorimetric method and an analysis chip 12B (hereinafter simply referred to as an “electrolyte chip 12B”) that is used for electrolyte concentration measurement using the electrode method. In the following description, when it is not necessary to distinguish between the colorimetric chips 12A and the electrolyte chip 12B, they are collectively referred to as the analysis chips 12. Details of the analysis chips 12 will be described later. The analysis chips 12 are an example of “analysis chips” according to the technology of the present disclosure. The colorimetric chips 12A are each an example of a “first analysis chip” according to the technology of the present disclosure, and the electrolyte chip 12B is an example of a “second analysis chip” according to the technology of the present disclosure.

The reader 20 is, for example, a code reader that reads item information provided on each of the analysis chips 12. Thus, the type and/or lot number of each of the analysis chips 12 is identified. The reader 20 is constituted by, for example, an image sensor such as a charge coupled device (CCD) or a complementary metal oxide semiconductor (CMOS). The item information read by the reader 20 is output to the control device 90.

In the test-substance spotting unit 30, a test substance such as blood plasma, whole blood, serum, or urine is spotted onto the analysis chips 12. The test-substance spotting unit 30 is provided with a chip support base 31, and spotting of the test substance sample onto each of the analysis chips 12, which have been transported to the chip support base 31, is performed on the chip support base 31. The spotting of the test substance sample is performed by the test-substance spotting mechanism 50, which will be described later. The chip support base 31 is disposed adjacent to the holding base 11.

The first chip transport mechanism 40 transports the analysis chips 12 from the chip set unit 10 to the test-substance spotting unit 30 and further transports them from the test-substance spotting unit 30 to the incubator 60. The first chip transport mechanism 40 includes a chip transport member 42 in the form of a thin plate and a driving mechanism 44 that causes the chip transport member 42 to reciprocate in a direction in which the chip set unit 10, the test-substance spotting unit 30, and the incubator 60 are arranged. The driving mechanism 44 is, for example, a linear actuator. The chip transport member 42 is slidably supported by a guide rod (not illustrated) and is caused to reciprocate by the driving mechanism 44. The first chip transport mechanism 40 is an example of a “transfer mechanism” according to the technology of the present disclosure.

The test-substance spotting mechanism 50 includes a nozzle 52, a suction and discharge mechanism (not illustrated), and a moving mechanism that moves the nozzle 52. The test-substance spotting mechanism 50 draws in the test substance sample from a test-substance container (not illustrated) and spots the test substance onto the analysis chips 12 in the test-substance spotting unit 30.

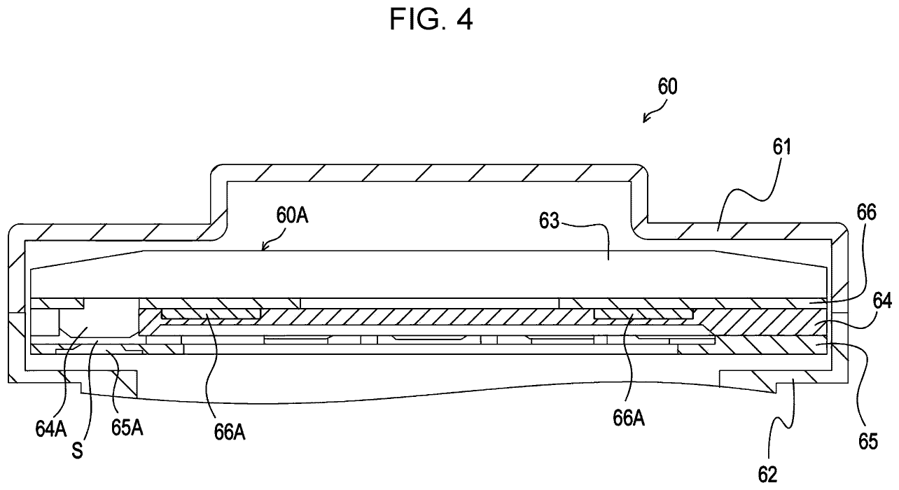

The incubator 60 can accommodate the plurality of analysis chips 12 therein. The incubator 60 has a heater 66A (see FIG. 4) therein and has a function of heating the analysis chips 12 in the incubator 60 to a predetermined target temperature and maintaining the analysis chips 12 at the target temperature. More specifically, the incubator 60 maintains, at a target temperature, an atmosphere around regions of the analysis chips 12 onto which the test substance sample is spotted. The target temperature is, for example, 37° C. Note that the target temperature may vary depending on the types of the analysis chips 12. By heating the analysis chips 12 in the incubator 60 to the predetermined target temperature and maintaining the analysis chips 12 at the target temperature, the incubator 60 promotes a reaction between a reagent and the test substance sample on each of the analysis chips 12. The incubator 60 is an example of an “incubator” according to the technology of the present disclosure.

The incubator 60 includes an upper cover 61 and a lower cover 62. Various members constituting the incubator 60 and the analysis chips 12 are accommodated in a space formed by the upper cover 61 and the lower cover 62. A rotary sleeve 67 is provided at a lower portion of the lower cover 62. A bearing 68 is disposed at a lower portion of an outer periphery of the rotary sleeve 67, and the rotary sleeve 67 is rotatably supported by the bearing 68. A rotational force is transmitted to a member provided inside the incubator 60 via the rotary sleeve 67.

The optical measurement unit 70 is a unit that performs colorimetric measurement, which is an optical density measurement using the colorimetric method, on the analysis chips 12. The potential measurement unit 76 is a unit that performs electrolyte measurement, which is a measurement of electrolyte concentration using an electrode method, on the analysis chips 12. The optical measurement unit 70 and the potential measurement unit 76 are provided below the lower cover 62 at an outer peripheral portion of the incubator 60. Details of the optical measurement unit 70 and the potential measurement unit 76 will be described later. The optical measurement unit 70 and the potential measurement unit 76 are each an example of a “measurement unit” according to the technology of the present disclosure. The optical measurement unit 70 is an example of a “first measurement unit” according to the technology of the present disclosure, and the potential measurement unit 76 is an example of a “second measurement unit” according to the technology of the present disclosure.

The second chip transport mechanism 80 is provided inside the incubator 60 and transports the analysis chips 12, which are located inside the incubator 60, from the inside to the outside of the incubator 60. The second chip transport mechanism 80 includes a slide bar 82 and a motor 86. The motor 86 operates under control of a processor 90A. The second chip transport mechanism 80 transports the analysis chips 12 by receiving power from the motor 86 and moving the slide bar 82 from the inside to the outside of the incubator 60. The second chip transport mechanism 80 is an example of a “return mechanism” and a “discard mechanism” according to the technology of the present disclosure.

The control device 90 performs overall operational control of the analyzer 100. Although the configuration of the control device 90 is not particularly limited, the control device 90 is implemented by, for example, a computer including the processor 90A constituted by a central processing unit (CPU), a non-volatile memory (NVM), random-access memory (RAM), and the like.

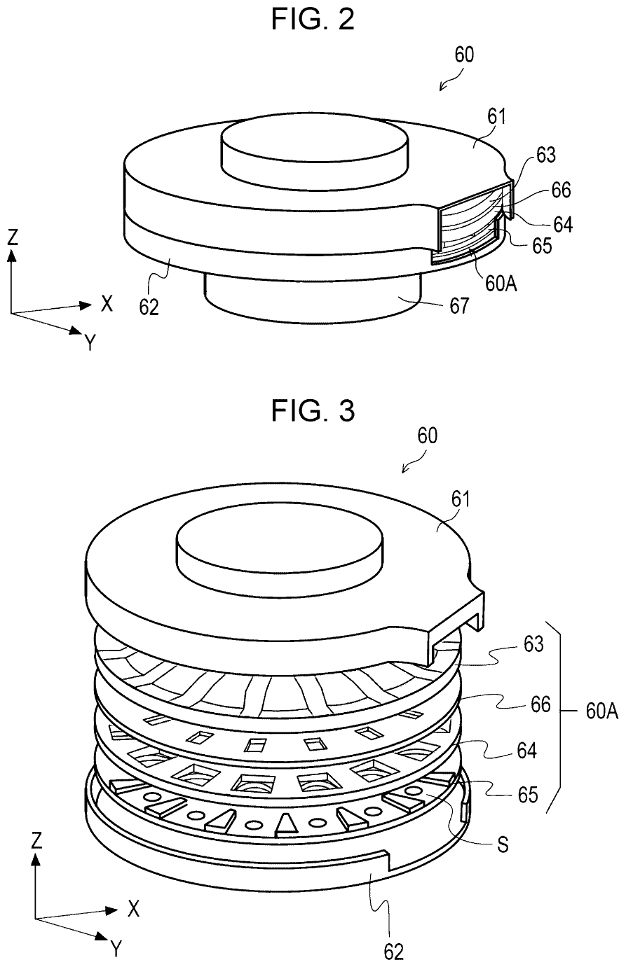

FIG. 2 is an external perspective view of the incubator 60. FIG. 3 is an exploded perspective view of the incubator 60. FIG. 4 is a sectional view of the incubator 60.

As an example, as illustrated in FIG. 2, FIG. 3, and FIG. 4, the incubator 60 has a rotating body 60A that is formed of four disc-shaped members and that is disposed in a space formed between the upper cover 61 and the lower cover 62. The rotating body 60A rotates inside the incubator 60, with a vertical direction (Z direction illustrated in FIG. 2 and FIG. 3) as a direction of a rotational axis. The rotating body 60A includes an upper member 63, a heater pressing member 66, a chip pressing member 64, and a rotary table 65.

The upper member 63 is provided at a topmost portion of the rotating body 60A. An opening (not illustrated) is formed at the center of the rotating body 60A including the upper member 63, and a cable for supplying power to the heater 66A and the like is disposed through the opening.

The heater pressing member 66 is provided between the upper member 63 and the chip pressing member 64. The heater pressing member 66 presses the heater 66A from above, the heater 66A being disposed between the heater pressing member 66 and the chip pressing member 64. The heater 66A functions as a heat source for heating the interior of the incubator 60 to a predetermined target temperature. The heater 66A is, for example, a ceramic heater. The heater 66A is located below the inner peripheral side of the heater pressing member 66. Heat that is generated from the heater 66A is transferred through the members inside the incubator 60, so that the internal space of the incubator 60 including cells S is set to the predetermined target temperature.

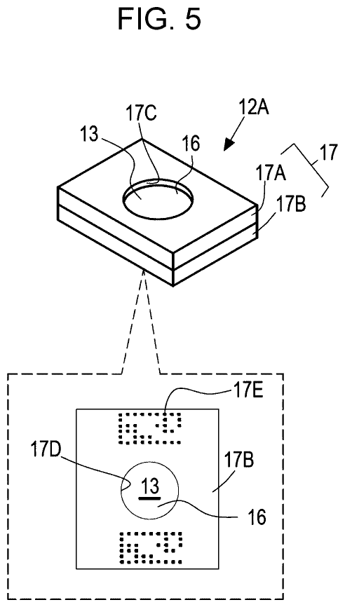

The chip pressing member 64 is provided between the heater pressing member 66 and the rotary table 65. The chip pressing member 64 presses the analysis chips 12, which are placed on the rotary table 65, from above. This suppresses displacement of the analysis chips 12 on the rotary table 65. In addition, the chip pressing member 64 covers a reaction region 13 (see FIG. 5) of each of the analysis chips 12 so as to suppress evaporation of the test substance sample spotted on the analysis chip 12.

The rotary table 65 is a table on which the analysis chips 12 are placed. The rotary table 65 has the cells S that are a plurality of regions partitioned from each other along a circumferential direction, and each of the analysis chips 12 can be accommodated in one of the cells S. The rotary table 65 is an example of a “rotary table” according to the technology of the present disclosure.

As described above, the analysis chips 12 include the colorimetric chips 12A and the electrolyte chip 12B. FIG. 5 is an external perspective view illustrating a structural example of the colorimetric chips 12A. As illustrated in FIG. 5 as an example, each of the colorimetric chips 12A has the reaction region 13 in which the reagent is immobilized. The reagent reacts with the test target analyte so as to produce a substance that develops a specific color. The substance that develops color by this reaction will hereinafter be referred to as a reactant. As the reagent, for example, a solid-phase dry reagent that is in a dry state at least at the time of shipment is used. The test substance sample is spotted onto the reaction region 13 of each of the colorimetric chips 12A. The reaction region 13 is an example of a “reaction region” according to the technology of the present disclosure.

Each of the colorimetric chips 12A has a carrier 16 onto which the test substance sample is spotted, and the carrier 16 is accommodated in a case 17. The case 17 is constituted by a first case 17A and a second case 17B, and the carrier 16 is accommodated by being sandwiched between the first case 17A and the second case 17B. The first case 17A has an opening 17C that functions as a drop port for spotting the test substance sample onto the reaction region 13. The second case 17B has an opening 17D for irradiating light onto the reaction region 13. The carrier 16 is exposed through the opening 17C of the first case 17A, which constitutes front surface of the colorimetric chip 12A. In addition, the carrier 16 is exposed through the opening 17D of the second case 17B, which constitutes a rear surface of the colorimetric chip 12A. A region in which the carrier 16 is exposed through the opening 17D constitutes the reaction region 13 where the reagent is immobilized. The second case 17B is provided with an information code 17E in which item information relating to measurement items are encoded. The information code 17E is, for example, a pattern in which a plurality of dots are arranged, and the dot arrangement pattern differs for each measurement item. Obviously, a one-dimensional barcode, a two-dimensional barcode, or the like may be used as the information code 17E.

By changing the reagent that reacts with the test substance sample, test substance sample can be analyzed for a plurality of measurement items. Two or more of the colorimetric chips 12A are prepared for each measurement item, and a reagent corresponding to the measurement item is immobilized on the carriers 16 of the colorimetric chips 12A. The item information provided on each of the colorimetric chips 12A includes identification information of the reagent immobilized on the carrier 16 of the colorimetric chip 12A (e.g., information capable of specifying that can identify the name and identification code of the reagent), or identification information of the measurement item measured by the reagent (e.g., information that can identify the name and identification code of the item).

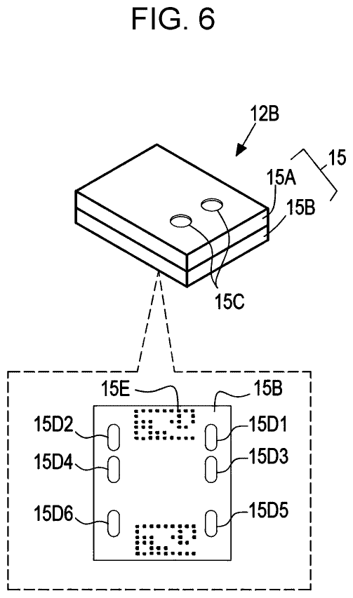

FIG. 6 is an external perspective view illustrating a structural example of the electrolyte chip 12B.

As illustrated in FIG. 6 as an example, the electrolyte chip 12B has, inside a case 15, multilayer film electrodes (not illustrated) and a distribution member (not illustrated) that correspond to ions to be measured (e.g., Na ions, K ions, and Cl ions). The case 15 is constituted by a first case 15A and a second case 15B, and the multilayer film electrodes and the distribution member are accommodated by being sandwiched between the first case 15A and the second case 15B. The first case 15A has two openings 15C. The test substance sample is spotted onto one of the openings 15C, and a reference solution is spotted onto the other opening 15C. The distribution member delivers the test substance sample to one ends of the multilayer film electrodes and the reference solution to the other ends of the multilayer film electrodes.

The second case 15B has holes 15D corresponding to the number of the multilayer film electrodes. Measurement electrodes (not illustrated) are capable of coming into contact with the one ends and the other ends of the multilayer film electrodes via the holes 15D. In the case illustrated in FIG. 6, six holes 15D1 to 15D6 are formed. For example, the holes 15D1 and 15D2 respectively communicate with one end and the other end of the multilayer film electrode for measuring Cl ion concentration. In addition, the holes 15D3 and 15D4 respectively communicate with one end and the other end of the multilayer film electrode for measuring K ion concentration. Furthermore, the holes 15D5 and 15D6 respectively communicate with one end and the other end of the multilayer film electrode for measuring Na ion concentration.

The second case 15B is provided with an information code 15E in which item information relating to measurement items are encoded. The information code 15E has a configuration and a function that are similar to those of the information code 17E provided on each of the colorimetric chips 12A.

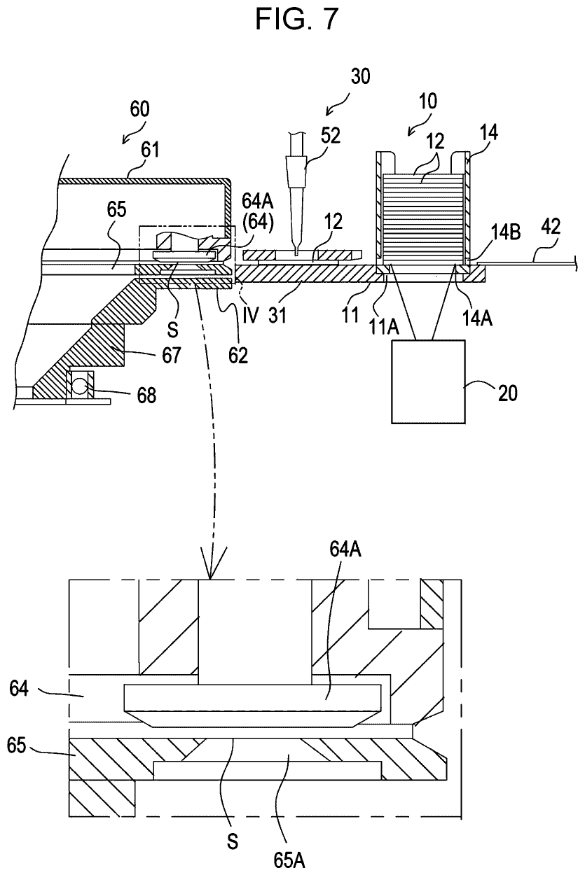

FIG. 7 is a schematic diagram illustrating a partial configuration of the analyzer 100.

As illustrated in FIG. 7 as an example, a side wall of the stocker 14 has an insertion port 14B into which the chip transport member 42 is inserted. The chip transport member 42 is inserted into the stocker 14 through the insertion port 14B.

The stocker 14 has an opening 14A formed in a bottom surface thereof. Each of the colorimetric chips 12A is accommodated in a position in which its surface on which the information code 17E has been recorded faces toward the opening 14A of the stocker 14. Accordingly, in the stocker 14, the information code 17E of the lowermost colorimetric chip 12A that is closest to the opening 14A is exposed through the opening 14A. Similarly, the holding base 11, on which the stocker 14 is disposed, has an opening 11A. Thus, the information code 17E of the lowermost colorimetric chip 12A in the stocker 14 is exposed toward the reader 20 through the opening 11A of the holding base 11 and the opening 14A of the stocker 14. The reader 20 is disposed below the holding base 11 and reads the information code 17E that is exposed through the opening 11A and the opening 14A. Here, a case has been described in which the information code 17E of each of the colorimetric chips 12A is read by the reader 20, and the same applies to the information code 15E of the electrolyte chip 12B.

The chip transport member 42 is pressed against the lowermost analysis chip 12 among the analysis chips 12, which are accommodated and stacked on top of one another. In this state, the chip transport member 42 moves toward the incubator 60, so that the analysis chip 12 passes over the chip support base 31 and transported into the incubator 60.

The incubator 60 has the chip pressing member 64 that presses the analysis chips 12, which are loaded in the cells S, from above. The chip pressing member 64 has a plurality of protrusions 64A each of which is arranged at a position where it faces one of the cells S. The protrusions 64A are biased downward by a biasing member (not illustrated). A slit-shaped space is formed between the protrusions 64A and the cells S, and the analysis chips 12 are loaded in this space. The protrusions 64A press the analysis chips 12, which are loaded in the cells S, from above. This suppresses movement of each of the analysis chips 12 in the corresponding cell S (e.g., displacement of the analysis chip 12 in the radially outward direction due to centrifugal force generated on the analysis chip 12 as a result of rotation of the rotary table 65).

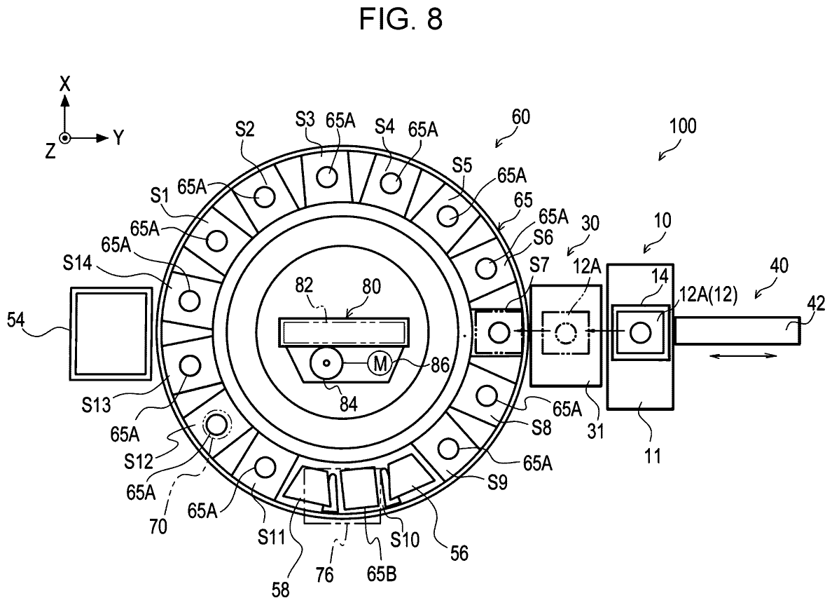

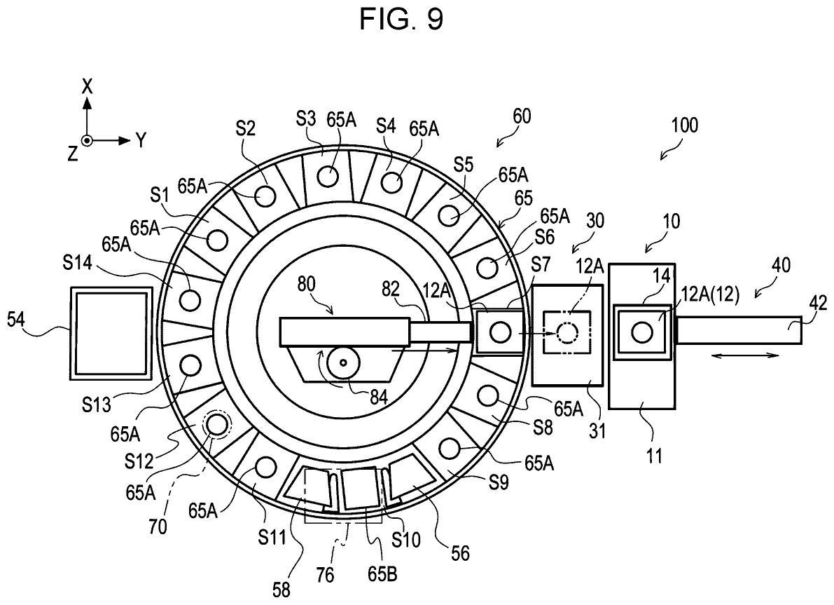

FIG. 8 and FIG. 9 are each a plan view illustrating a configuration example of the analyzer 100.

As illustrated in FIG. 8 as an example, the rotary table 65 is provided with a plurality of cells S1 to S14 in which the analysis chips 12 are to be loaded. In the case illustrated in FIG. 8, the rotary table 65 has an annular shape, and the 14 cells S1 to S14 are arranged thereon in the circumferential direction. The rotary table 65 rotates with the vertical direction (Z direction illustrated in FIG. 8) as a rotational axis and sequentially transports the analysis chips 12 placed on the plurality of cells S to a measurement position (i.e., a position that faces the optical measurement unit 70 or the potential measurement unit 76). The plurality of analysis chips 12 on the rotary table 65 are heated to a predetermined temperature in the incubator 60. In the following description, when it is necessary to distinguish among the plurality of cells S1 to S14, sub-reference numerals 1 to 14 are assigned to them. When such distinction is unnecessary, they will be simply referred to as the cells S.

The cells S1 to S9 and S11 to S14 of the rotary table 65 hold the colorimetric chips 12A. An opening window 65A for photometric measurement is formed at the center of a bottom surface of each of the cells S1 to S9 and S11 to S14, and the optical density of each of the colorimetric chips 12A is measured by the optical measurement unit 70 through the corresponding opening window 65A. The cells S1 to S9 and S11 to S14 are each an example of a “first cell” according to the technology of the present disclosure. A black density plate 56 and a white density plate 58 are provided on respective sides of the cell S10. Opening windows (not illustrated) are also formed below the black density plate 56 and the white density plate 58, one window for each plate.

The optical measurement unit 70 irradiates each of the colorimetric chips 12A with light (measurement light L0, which will be described later as an example) and receives light reflected from the colorimetric chip 12A. As a result, the optical measurement unit 70 measures the optical density corresponding to the reaction state between the test substance sample and the reagent in each of the colorimetric chips 12A. The black density plate 56 and the white density plate 58 are each a density plate for obtaining a reference optical density that is referred to when the optical density of each of the colorimetric chips 12A is measured. Before measuring the optical density of each of the colorimetric chips 12A, the optical measurement unit 70 irradiates each of the black density plate 56 and the white density plate 58 with the measurement light L0 so as to measure a black reference optical density and a white reference optical density. The optical density of each of the colorimetric chips 12A is measured as a relative density within a range defined by the black reference optical density as a lower limit and the white reference optical density as an upper limit. As will be described later, the optical measurement unit 70 has a plurality of light sources that emit the measurement light L0 of a plurality of different wavelengths, and each of the wavelengths is used in accordance with the type of the colorimetric chips 12A (i.e., measurement item). The black reference optical density and the white reference optical density are measured for each wavelength of the measurement light L0.

The cell S10 of the rotary table 65 holds the electrolyte chip 12B. An opening window 65B for potential measurement is formed in a bottom surface of the cell S10. The ion concentration of the electrolyte chip 12B is measured by the potential measurement unit 76 through the opening window 65B. The cell S10 is an example of a “second cell” according to the technology of the present disclosure.

When the rotary table 65 is viewed in plan view (viewed from a direction opposite to the Z direction illustrated in FIG. 8), the second chip transport mechanism 80 is disposed inside the plurality of cells S of the rotary table 65. The second chip transport mechanism 80 is a mechanism capable of transporting the analysis chips 12 from the inside to the outside of the incubator 60. The second chip transport mechanism 80 includes, for example, the slide bar 82 and a pinion gear 84. A force that causes the pinion gear 84 to rotate is transmitted to the pinion gear 84 from the motor 86. As a result, the pinion gear 84 rotates. The slide bar 82 is a plate-shaped member that has a thickness approximately equal to that of each of the colorimetric chips 12A. A rack gear (not illustrated) is formed on a surface of the slide bar 82 that faces the pinion gear 84, and the rack gear meshes with the pinion gear 84, so that the slide bar 82 moves. The slide bar 82 is an example of a “slide bar” according to the technology of the present disclosure.

Note that, although an operation of transporting the analysis chips 12 using the second chip transport mechanism 80 in the rotary table 65 will be described below, taking one of the colorimetric chips 12A as an example, a similar transport operation is also applied to the electrolyte chip 12B. In addition, for convenience of description, although a case will be described below in which one of the analysis chips 12 is held in one of the cells S of the rotary table 65, it is obvious that the analysis chips 12 may each be held in one of the plurality of cells S of the rotary table 65 and that the transport operation using the second chip transport mechanism 80 may be applied to each of the plurality of analysis chips 12.

The colorimetric chip 12A is taken out from the stocker 14 and then transported into the incubator 60 through the chip support base 31 by the first chip transport mechanism 40. In the case illustrated in FIG. 8, the colorimetric chip 12A is loaded in the cell S7. Then, the colorimetric chip 12A is heated to a target temperature (e.g., 37° C.) in the incubator 60.

As illustrated in FIG. 9 as an example, after the colorimetric chip 12A has reached a predetermined temperature, the colorimetric chip 12A is returned from the inside of the incubator 60 to a spotting position by the second chip transport mechanism 80. Here, the spotting position is a position on the chip support base 31 where the test substance is spotted by the test-substance spotting unit 30. In the case illustrated in FIG. 9, the pinion gear 84 rotates clockwise in plan view, so that the slide bar 82 moves in a direction toward the spotting position (Y direction illustrated in FIG. 9).

The slide bar 82 pushes the colorimetric chip 12A, so that the colorimetric chip 12A moves from the inside of the incubator 60 toward the spotting position. At the spotting position, the test substance is spotted onto the colorimetric chip 12A by the test-substance spotting unit 30. In this case, the temperature of the colorimetric chip 12A is close to the temperature predetermined in the incubator 60 compared to the case where spotting is performed on the colorimetric chip 12A without heating the colorimetric chip 12A after the colorimetric chip 12A has been taken out from the stocker 14. After the spotting has been performed on the colorimetric chip 12A, the colorimetric chip 12A is transported into the incubator 60 again.

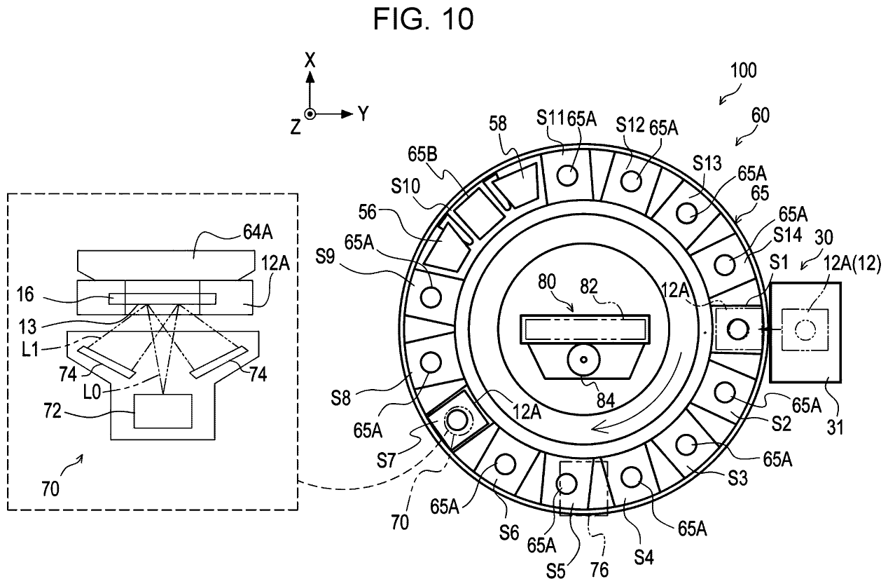

FIG. 10 is a schematic diagram illustrating a state of measurement using the colorimetric method in the analyzer 100.

As illustrated in FIG. 10 as an example, after the colorimetric chip 12A has been transported into the incubator 60 again, the colorimetric measurement is performed on the colorimetric chip 12A in the incubator 60. The optical measurement unit 70 includes a light source 72 and photodetectors 74. The light source 72 irradiates the reaction region 13 with the measurement light L0, and the photodetectors 74 receive output light L1 that is light reflected from the reaction region 13 and perform photoelectric conversion.

The light source 72 irradiates light toward the reaction region 13 through the opening 17D of the case 17 of the colorimetric chip 12A. The wavelength range of the light is determined in accordance with the test target analyte (i.e., measurement item). For example, in the present case, a reactant that develops a specific color is produced as a result of a reaction between the test target analyte and the reagent as described above. Since the light irradiated by the light source 72 is the measurement light L0 for measuring the reactant, the wavelength range is determined in accordance with the color developed by the reactant. The measurement light L0 in the present case is, for example, light including a wavelength range that is absorbed by the reactant for the purpose of measuring the reactant.

It is preferable that the wavelength range of the measurement light L0 be limited to a wavelength range that is absorbed by the reactant. As the light source 72, for example, a light source such as a light emitting diode (LED), an organic electroluminescence (EL) device, or a semiconductor laser is used. In FIG. 10, only the single light source 72 is illustrated. However, in practice, a plurality of light sources 72 that output a plurality of light beams in different wavelength ranges are provided in order to measure the plurality of measurement items. Note that, instead of providing the plurality of light sources 72, a light source, such as a white light source, that emits light over a relatively broad wavelength range and a band-pass filter that transmits only a specific wavelength range may be combined together so as to generate the measurement light L0 of different wavelengths.

The photodetectors 74 detect the output light L1 emitted by the colorimetric chip 12A when the colorimetric chip 12A is irradiated with the measurement light L0. The photodetectors 74 are light-receiving elements (e.g., photodiodes or the like) that output detection signals corresponding to the amount of light. In the present case, the two photodetectors 74 are provided. The photodetectors 74 output the detection signals to the control device 90 (see FIG. 1). The control device 90 obtains the detection signals corresponding to the output light L1 and derives the concentration of the test target analyte.

In the reaction region 13, a reaction occurs between the test substance sample and the reagent, resulting in the generation of a reactant that develops a specific color. As the reactant is generated, the color of the reaction region 13 changes, and this color change appears as a change in the optical density of the reaction region 13. The output light L1 is light that corresponds to the optical density of the reaction region 13 and reflects information regarding the reactant due to occurrences such as light absorption by the reactant. The optical density of the reaction region 13 changes in accordance with the amount of the reactant, and the amount of the reactant indicates the concentration of the test target analyte in the test substance sample. Thus, the concentration of the test target analyte can be measured on the basis of the detection signals representing the output light L1, which includes the information regarding the reactant.

For example, the colorimetric measurement of the plurality of colorimetric chips 12A on the rotary table 65 is performed multiple times at predetermined intervals while the rotary table 65 is being rotated. When the number of measurements reaches a predetermined number, the colorimetric measurement is terminated. Then, the concentration of the test target analyte is derived on the basis of a plurality of detection signals corresponding to the optical density values measured in the multiple measurements.

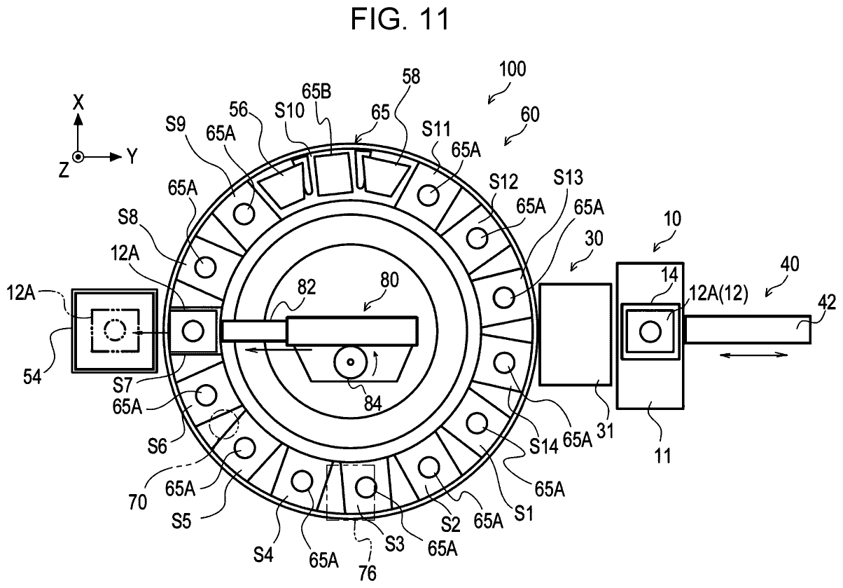

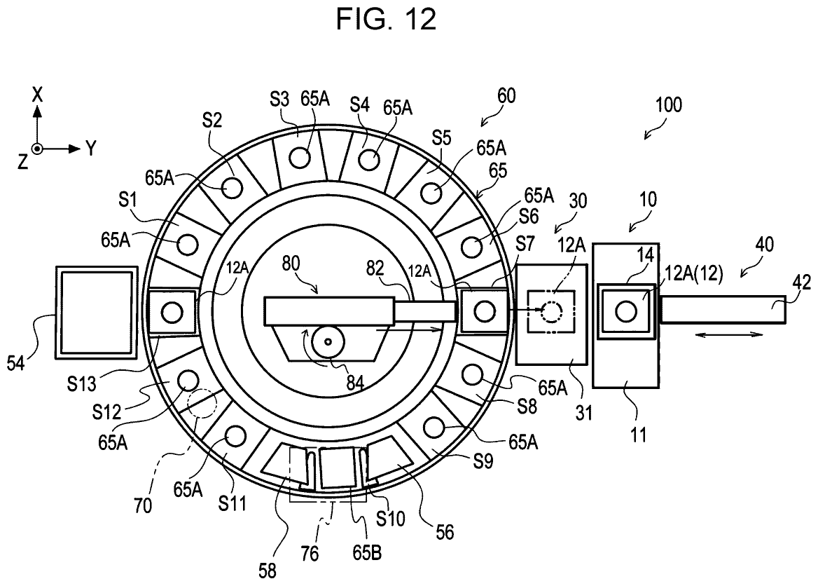

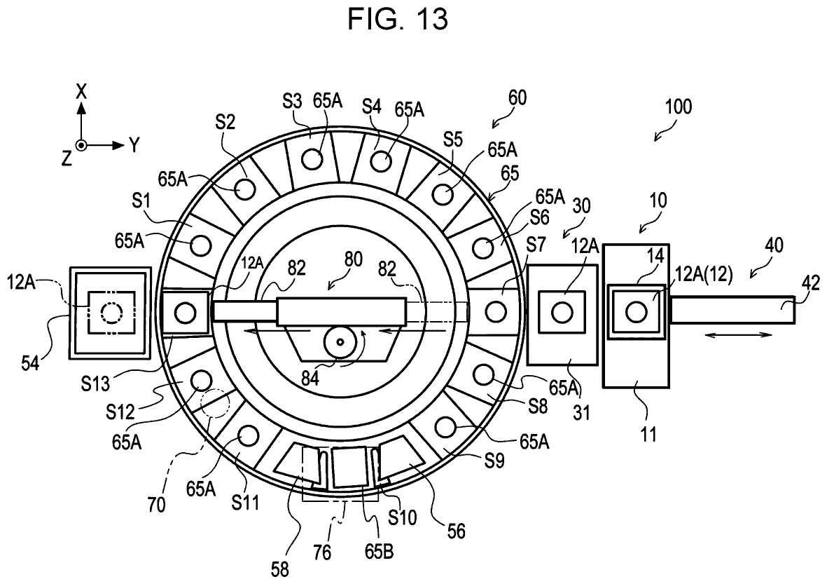

FIG. 11, FIG. 12, and FIG. 13 are each a plan view illustrating a configuration example of the analyzer 100.

As illustrated in FIG. 11 as an example, one of the colorimetric chips 12A that has undergone the colorimetric measurement is transported by the rotary table 65 to a position where the colorimetric chip 12A can be transported toward a discard position. After that, the colorimetric chip 12A is transported by the second chip transport mechanism 80 from the inside of the incubator 60 to the discard position. For example, the discard position is located inside a container 54 that is capable of accommodating the colorimetric chips 12A that has been used. In the case illustrated in FIG. 11, the pinion gear 84 rotates counterclockwise, so that the slide bar 82 moves in a direction toward the discard position (the direction opposite to the Y direction illustrated in FIG. 11). The slide bar 82 pushes the colorimetric chip 12A, so that the colorimetric chip 12A moves from the inside of the incubator 60 toward the discard position.

In this manner, the second chip transport mechanism 80 is capable of performing both an operation of returning each of the colorimetric chips 12A from the inside of the incubator 60 toward the spotting position and an operation of discarding each of the colorimetric chips 12A from the inside of the incubator 60 toward the discard position. In other words, the second chip transport mechanism 80 functions as a return mechanism that returns the colorimetric chips 12A toward the spotting position and as a discard mechanism that discards the colorimetric chips 12A, and components (e.g., the slide bar 82, the pinion gear 84, and so forth) constituting the second chip transport mechanism 80 are shared by the return mechanism and the discard mechanism.

Here, as an example of the transport operation on the rotary table 65 using the second chip transport mechanism 80, an exemplary mode has been described in which the return operation and the discard operation for the colorimetric chips 12A are performed at different timings. However, this is merely an example. The return operation and the discard operation may be continuously performed by the second chip transport mechanism 80.

As illustrated in FIG. 12 as an example, the slide bar 82 pushes one of the colorimetric chips 12A first, so that the colorimetric chip 12A moves from the inside of the incubator 60 toward the spotting position. Then, the slide bar 82 returns to its original position before the drive by the counterclockwise rotation of the pinion gear 84. As illustrated in FIG. 13 as an example, the slide bar 82 moves continuously in the direction toward the discard position (the direction opposite to the Y direction illustrated in FIG. 13). The slide bar 82 pushes the colorimetric chip 12A that has undergone the measurement, so that the colorimetric chip 12A moves from the inside of the incubator 60 toward the discard position. In this manner, the return operation and the discard operation for the colorimetric chip 12A are implemented as a series of operations of the slide bar 82. In this case, the discard position and the spotting position are arranged at an angular interval of 180 degrees in the circumferential direction of the rotary table 65. As a result, the return operation and the discard operation are implemented as a series of operations by linear movements of the slide bar 82 along the radial direction.

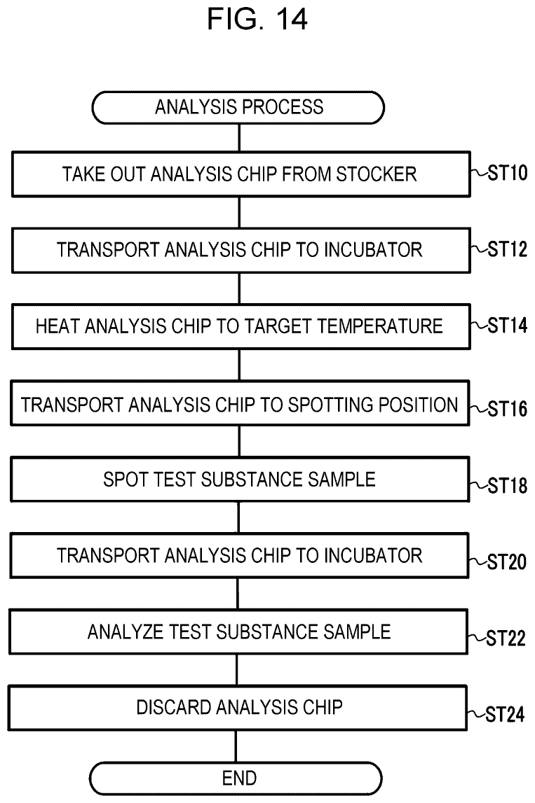

A process of analyzing a test substance sample in the analyzer 100 according to the present embodiment will now be described with reference to FIG. 14. FIG. 14 is a flow chart illustrating the process of analyzing the test substance sample in the analyzer 100.

In the analysis process illustrated in FIG. 14 as an example, first, each of the analysis chips 12 is taken out from the stocker 14 by the first chip transport mechanism 40 in step ST10 (see FIG. 8). After that, the analysis process proceeds to step ST12.

In step ST12, each of the analysis chips 12 taken out from the stocker 14 in step ST10 is transported into the incubator 60 (see FIG. 8). After that, the analysis process proceeds to step ST14.

In step ST14, the analysis chips 12 transported into the incubator 60 in step ST12 are heated to a target temperature (e.g., 37° C.) in the incubator 60 (see FIG. 8). After that, the analysis process proceeds to step ST16.

In step ST16, the analysis chips 12, which have been heated to the target temperature in step ST14, are each transported from the inside of the incubator 60 toward the spotting position by the second chip transport mechanism 80 (see FIG. 9). After that, the analysis process proceeds to step ST18.

In step ST18, the test-substance spotting unit 30 spots a test substance sample onto each of the analysis chips 12 transported to the spotting position in step ST16 (see FIG. 9). After that, the analysis process proceeds to step ST20.

In step ST20, each of the analysis chips 12, on which the test substance sample has been spotted in step ST18, is transported into the incubator 60 (see FIG. 10). After that, the analysis process proceeds to step ST22.

In step ST22, each of the analysis chips 12, which have been transported into the incubator 60 in step ST20, is transported to the measurement position inside the incubator 60, and the test substance sample on the analysis chip 12 is analyzed (see FIG. 10). After that, the analysis process proceeds to step ST24.

In step ST24, each of the analysis chips 12, on which the test substance sample was analyzed in step ST22, is transported within the incubator 60 to a position where the analysis chip 12 can be transported toward the discard position, and is then transported from the inside of the incubator 60 toward the discard position by the second chip transport mechanism 80 (see FIG. 11). As a result, the analysis process for the test substance sample is completed.

As described above, in the analyzer 100 according to the present embodiment, the analysis chips 12 are heated to the predetermined temperature within the incubator 60, and then, each of the analysis chips 12 is transported toward the spotting position by the second chip transport mechanism 80. The test substance sample is spotted onto each of the analysis chips 12 at the spotting position by the test-substance spotting unit 30. After the measurement has been performed inside the incubator 60, each of the analysis chips 12 is transferred toward the discard position by the second chip transport mechanism 80. In this manner, even when the incubator 60 is used for preheating the analysis chips 12, the operation of returning each of the preheated analysis chips 12 and the operation of discarding each of the analysis chips 12 after the measurement are implemented by the second chip transport mechanism 80. In other words, the second chip transport mechanism 80 functions as a return mechanism that returns each of the analysis chips 12 toward the spotting position and a discard mechanism that discards each of the analysis chips 12 after the measurement, and thus, a portion of the return mechanism and a portion of the discard mechanism are shared. Therefore, compared with the case where the return mechanism and the discard mechanism are provided separately from each other, size reduction and simplification of the structure of the analyzer 100 are achieved.

In the analyzer 100 according to the present embodiment, when the rotary table 65 is viewed in plan view (viewed from a direction opposite to the Z direction illustrated in FIG. 8), the second chip transport mechanism 80 is disposed inside the plurality of cells S, which are arranged along the circumferential direction of the rotary table 65. Thus, compared with the case where the return mechanism is disposed inside the plurality of cells S while the discard mechanism is disposed outside the plurality of cells S, a reduction in the size of the analyzer 100 is achieved.

In addition, in the analyzer 100 according to the present embodiment, the second chip transport mechanism 80 includes the slide bar 82, and the slide bar 82 pushes each of the analysis chips 12, which have been preheated, toward the spotting position. The slide bar 82 also pushes each of the analysis chips 12 after the measurement toward the discard position. In this manner, the slide bar 82 in the second chip transport mechanism 80 is used in both the return operation and the discard operation. In other words, the second chip transport mechanism 80 functions as the return mechanism and the discard mechanism, and the slide bar 82 is shared by the return mechanism and the discard mechanism. Since the slide bar 82 that performs linear movements is shared, for example, compared with the case where the return mechanism and the discard mechanism are implemented by a link mechanism, the size reduction and simplification of the structure of the analyzer 100 are achieved.

In the analyzer 100 according to the present embodiment, the discard position and the spotting position are arranged at an angular interval of 180 degrees in the circumferential direction of the rotary table 65. In the case where the analysis chips 12 are held in two of the cells S, the two cells S being arranged at an angular interval of 180 degrees in the rotary table 65, the spotting position and the discard position are arranged in a line. Thus, the return operation and the discard operation for the analysis chips 12 are implemented by the reciprocating motion of the slide bar 82. As a result, a simple operation, which is the linear reciprocation of the slide bar 82, is sufficient, and thus, simplification of the structure of the analyzer 100 is achieved.

For example, in order to perform measurement in a state where the analysis chips 12 are stationary, the rotary table 65 is often step-driven to alternately repeat stopping and rotating. By arranging the spotting position and the discard position in a line with the rotary table 65 interposed therebetween, returning one of the analysis chips 12 to the spotting position and discarding one of the analysis chips 12 can be performed continuously at a single stop timing, and thus, the measurement throughput in the analyzer 100 is also improved. In other words, the efficiency of the measurement operation in the analyzer 100 is improved.

In the analyzer 100 according to the present embodiment, the optical measurement unit 70 and the potential measurement unit 76 are provided. The optical measurement unit 70 performs measurement using the colorimetric method, and the potential measurement unit 76 performs measurement using the electrode method. The analysis chips 12 include the colorimetric chips 12A that are used for the colorimetric measurement and the electrolyte chip 12B for the potential measurement. The rotary table 65 is provided with the cells S1 to S9 and S11 to S14 in which the colorimetric chips 12A are to be held and the cell S10 in which the electrolyte chip 12B is to be held. The second chip transport mechanism 80 is used for both the colorimetric chips 12A and the electrolyte chip 12B. Even in the case where the colorimetric chips 12A and the electrolyte chip 12B that are different types of chips are used for measurement in the manner described above, the size reduction and simplification of the structure of the analyzer 100 are achieved.

In the analyzer 100 according to the present embodiment, the plurality of analysis chips 12 that are held in the plurality of cells S of the rotary table 65 are a plurality of types of analysis chips 12 for different measurement items. Accordingly, the plurality of types of analysis chips 12 for the different measurement items can be arranged on the rotary table 65, and thus, the test substance sample can be efficiently analyzed.

In the analyzer 100 according to the present embodiment, each of the analysis chips 12 is a dry analysis chip using a solid-phase reagent as a reagent. The analysis chips 12, each of which uses a solid-phase reagent, is a chip that generally has higher stiffness than, for example, a strip used in urinalysis. Thus, in the return operation and the discard operation performed by the second chip transport mechanism 80, the analysis chips 12 are less likely to deform and are more easily moved.

Note that, in the above-described embodiment, an exemplary mode has been described in which the second chip transport mechanism 80 has the slide bar 82 and the pinion gear 84 and in which the slide bar 82 performs, as a result of changing the direction of rotation of the pinion gear 84, pushing to the spotting position and pushing to the discard position. However, the technology of the present disclosure is not limited to this. For example, a configuration in which the entire second chip transport mechanism 80 rotates so as to change the direction in which the slide bar 82 pushes each of the analysis chips 12 may be employed.

In the above-described embodiment, a configuration example has been described in which the second chip transport mechanism 80 includes the single slide bar 82. However, the technology of the present disclosure is not limited to this. For example, the second chip transport mechanism 80 may include a slide bar for the discard operation and a slide bar for the return operation, and the pinion gear 84 may be configured to mesh with these two slide bars. In this case, the pinion gear 84 is shared by the return mechanism and the discard mechanism.

In the above-described embodiment, a configuration example has been described in which the second chip transport mechanism 80 is constituted by the slide bar 82, the pinion gear 84, and the motor 86. However, the technology of the present disclosure is not limited to this. For example, the second chip transport mechanism 80 may be a mechanism that uses a linear actuator to drive a rod-shaped member that pushes each of the analysis chips 12. In this case, the linear actuator and the rod-shaped member are shared by the return mechanism and the discard mechanism.

In the above-described embodiment, a configuration example has been described in which the potential measurement unit 76 measures the electrolyte chip 12B held in the cell S10 of the rotary table 65. However, the technology of the present disclosure is not limited to this. For example, the potential measurement unit 76 may measure the electrolyte chip 12B held by a measurement support that is provided outside the rotary table 65.

The described contents and illustrated contents given above are detailed descriptions of portions according to the technology of the present disclosure, and are merely examples of the technology of the present disclosure. For example, the descriptions relating to the above-described configurations, functions, operations, and effects are descriptions relating to examples of configurations, functions, operations, and effects of the portions according to the technology of the present disclosure. Consequently, it is needless to say that unnecessary portions may be omitted, new elements may be added, or substitutions may be made to the described contents and illustrated contents given above without departing from the gist of the technology of the present disclosure. In addition, in order to avoid complication and to facilitate understanding of the portions according to the technology of the present disclosure, the described contents and illustrated contents given above exclude descriptions relating to technical common sense and the like that are not particularly necessary for enabling implementation of the technology of the present disclosure.

All documents, patent applications, and technical standards mentioned in the present specification are incorporated herein by reference to the same extent as if each individual document, patent application, or technical standard was specifically and individually indicated to be incorporated by reference.

The disclosure of JP2023-008922 filed on Jan. 24, 2023 is incorporated herein by reference in its entirety.

The following appendixes are further disclosed with respect to the above-described embodiment.

### Appendix 1

An analyzer that analyzes a test substance sample by using a plurality of analysis chips onto which the test substance sample is to be spotted, the plurality of analysis chips being configured to be detachably loaded into the analyzer, the analyzer including:
an incubator that has a rotary table on which a plurality of cells each of which holds one of the plurality of analysis chips are arranged in a circumferential direction, the rotary table being configured to rotate in such a manner as to sequentially transport the plurality of analysis chips to a measurement position, and that heats the plurality of analysis chips on the rotary table to a predetermined temperature;
a measurement unit that is disposed at the measurement position and that measures the test substance sample spotted on the plurality of analysis chips;
a transfer mechanism that transfers the analysis chips from a spotting position at which the test substance sample is spotted onto the analysis chips to the cells inside the incubator;
a return mechanism that returns the analysis chips preheated in the incubator before the test substance sample is spotted onto the analysis chips from the cells inside the incubator to the spotting position; and
a discard mechanism that transfers the analysis chips having undergone measurement from the cells inside the incubator to a discard position,
wherein a portion of the return mechanism and a portion of the discard mechanism are shared.

### Appendix 2

The analyzer according to Appendix 1,
wherein, when the rotary table is viewed in plan view, the return mechanism and the discard mechanism are arranged inside a plurality of cells that are arranged in the circumferential direction of the rotary table.

### Appendix 3

The analyzer according to Appendix 1 or Appendix 2,
wherein the return mechanism has a slide bar that is disposed in such a manner as to be slidable in a radial direction of the rotary table and that pushes each of the analysis chips on the cells toward the spotting position located outside the rotary table,
wherein the discard mechanism has a slide bar that is disposed in such a manner as to be slidable in a radial direction of the rotary table and that pushes each of the analysis chips on the cells toward the discard position located outside the rotary table, and
wherein the slide bar is shared by the return mechanism and the discard mechanism.

### Appendix 4

The analyzer according to any one of Appendix 1 to Appendix 3,
wherein the spotting position and the discard position are arranged at an angular interval of 180 degrees in a circumferential direction of the rotary table.

### Appendix 5

The analyzer according to any one of Appendix 1 to Appendix 4,
wherein the measurement unit has a first measurement unit that optically measures a reaction state between the test substance sample and a reagent and a second measurement unit that measures concentration of an electrolyte contained in the test substance sample by using an electrode,
wherein the analysis chips include a first analysis chip to be measured by the first measurement unit and a second analysis chip to be measured by the second measurement unit,
wherein the rotary table has a first cell that holds the first analysis chip and a second cell that holds the second analysis chip, and
wherein the return mechanism and the discard mechanism are used for both the first analysis chip and the second analysis chip.

### Appendix 6

The analyzer according to any one of Appendix 1 to Appendix 5,
wherein the plurality of analysis chips held in the plurality of cells of the rotary table are a plurality of types of analysis chips for different measurement items.

### Appendix 7

The analyzer according to any one of Appendix 1 to Appendix 6,
wherein each of the analysis chips is a dry analysis chip using a solid-phase reagent as a reagent.

What is claimed is:

1. An analyzer that analyzes a test substance sample by using a plurality of analysis chips onto which the test substance sample is to be spotted, the plurality of analysis chips being configured to be detachably loaded into the analyzer, the analyzer comprising:
an incubator that has a rotary table on which a plurality of cells each of which holds one of the plurality of analysis chips are arranged in a circumferential direction, the rotary table being configured to rotate in such a manner as to sequentially transport the plurality of analysis chips to a measurement position, and that heats the plurality of analysis chips on the rotary table to a predetermined temperature;
a measurement unit that is disposed at the measurement position and that measures the test substance sample spotted on the plurality of analysis chips;
a transfer mechanism that transfers the analysis chips from a spotting position at which the test substance sample is spotted onto the analysis chips to the cells inside the incubator;
a return mechanism that returns the analysis chips preheated in the incubator before the test substance sample is spotted onto the analysis chips from the cells inside the incubator to the spotting position; and
a discard mechanism that transfers the analysis chips having undergone measurement from the cells inside the incubator to a discard position,
wherein the return mechanism and the discard mechanism share at least one component.

2. The analyzer according to claim 1,
wherein, when the rotary table is viewed in plan view, the return mechanism and the discard mechanism are arranged inside the plurality of cells that are arranged in the circumferential direction of the rotary table.

3. The analyzer according to claim 1,
wherein the return mechanism has a slide bar that is disposed in such a manner as to be slidable in a radial direction of the rotary table and that pushes each of the analysis chips on the cells toward the spotting position located outside the rotary table,
wherein the discard mechanism has a slide bar that is disposed in such a manner as to be slidable in the radial direction of the rotary table and that pushes each of the analysis chips on the cells toward the discard position located outside the rotary table, and
wherein the slide bar of the return mechanism and the slide bar of the discard mechanism are configured as a single common slide bar.

4. The analyzer according to claim 3,
wherein the spotting position and the discard position are arranged at an angular interval of 180 degrees in the circumferential direction of the rotary table.

5. The analyzer according to claim 1,
wherein the measurement unit has a first measurement unit that optically measures a reaction state between the test substance sample and a reagent and a second measurement unit that measures concentration of an electrolyte contained in the test substance sample by using an electrode,
wherein the analysis chips include a first analysis chip to be measured by the first measurement unit and a second analysis chip to be measured by the second measurement unit,
wherein the rotary table has a first cell that holds the first analysis chip and a second cell that holds the second analysis chip, and
wherein the return mechanism and the discard mechanism are used for both the first analysis chip and the second analysis chip.

6. The analyzer according to claim 1,
wherein the plurality of analysis chips held in the plurality of cells of the rotary table are a plurality of types of analysis chips for different measurement items.

7. The analyzer according to claim 1,
wherein each of the analysis chips is a dry analysis chip using a solid-phase reagent as a reagent.
